(19) United States
(12) Patent Application Publication
(10) Pub. No.: US 2026/0236790 A1
(43) Pub. Date: Aug. 13, 2026

(54) SYSTEM AND METHOD FOR DUAL VARIABLE MODEL ROUTING CONTROL

(71) Applicant: Quantiphi, Inc., Marlborough, MA (US)

(72) Inventors: Dagnachew Birru, Marlborough, MA (US); Amit Singh Bhatti, Mumbai (IN); Siva Prasad Sompalli, Mumbai (IN); Vishal Vaddina, Toronto, Ontario (CA)

(21) Appl. No.: 19/632,642

(22) Filed: Mar. 30, 2026

(51) Int. Cl. G06N 3/0985; G06N 3/045

(52) U.S. Cl. CPC G06N 3/0985; G06N 3/045

(57) ABSTRACT

A method for dual variable model routing control is disclosed. The method includes maintaining a target accuracy value (τ) and a scalar dual variable (λ). The method includes receiving an input query from external device. The method includes determining model selection preference for selecting Machine Learning (ML) model from ML models based on input query and target accuracy value (τ). The method may include updating scalar dual variable (λ) based on realized accuracy associated with routed input queries relative to target accuracy value (τ). Further, the method includes updating model-selection preference based on scalar dual variable (λ). The method includes applying updated scalar dual variable (λ) to accuracy-shortfall penalty associated with difference between realized accuracy and target accuracy value (τ). The method includes selecting one ML model from the plurality of ML model based on updated model-selection preference and cost associated with selected ML model, in a single-pass routing operation.

### TECHNICAL FIELD

The present disclosure relates to Machine Learning (ML), and more specifically to a system and method for dual variable model routing control.

### BACKGROUND OF THE INVENTION

The subject matter disclosed in the background section should not be assumed or construed to be prior art merely because of its mention in the background section. Similarly, any problem statement mentioned in the background section or its association with the subject matter of the background section should not be assumed or construed to have been previously recognized in the prior art.

Machine learning systems are increasingly deployed in production environments to process diverse input queries using one or more candidate models having different accuracy, latency, and computational cost characteristics. In many practical deployments, a routing mechanism is used to determine which model should handle a given input query. Such routing is often performed in environments in which resource utilization, inference cost, and service quality are all important operational considerations.

In conventional systems, model routing decisions are commonly based on fixed heuristics, static thresholds, or pre-trained selectors that estimate expected performance for different classes of queries. For example, a lower-cost model may be selected for routine queries, while a higher-capability and higher-cost model may be selected for more complex queries. In some cases, selection policies are configured using pre-defined trade-off preferences between cost and accuracy or are trained offline using historical data. However, operating conditions in real-world deployments are often dynamic and non-stationary. Query complexity, traffic composition, label quality, user expectations, and model behaviour may change over time. As a result, a routing strategy that is adequate during one operating period may fail to maintain a desired service level during another operating period. In particular, systems that rely on static trade-off settings or offline-calibrated routing preferences may exhibit degraded ability to maintain a target level of output quality or accuracy as traffic patterns evolve.

Further, conventional routing approaches often evaluate performance and cost using objective functions that are optimized during training, but such approaches may not adequately enforce runtime service level requirements. Even where online adaptation mechanisms are used, such mechanisms may primarily focus on general performance optimization or queue management rather than direct enforcement of an accuracy-oriented service level target. In some systems, adaptation may require retraining, reconfiguration of the selector, or dependence on model-specific routing structures, thereby increasing operational complexity and limiting portability across deployments.

Additionally, routing systems that attempt to respond aggressively to short-term fluctuations may become unstable, leading to oscillatory selection behaviour, excessive switching between models, or inefficient use of computational resources. Such instability may be exacerbated in the presence of noisy feedback, delayed quality measurements, or bursty traffic conditions. These issues may reduce predictability of service quality and complicate deployment in large-scale inference environments.

Therefore, there exists a need for improved computational methods for dynamically routing queries while maintaining target accuracy under changing runtime conditions.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

In an embodiment, a system for dual variable model routing control is disclosed. The system includes a Service Level Agreement (SLA) controller including a memory configured to store executable instructions, a target accuracy value (τ), and a controller state comprising a scalar dual variable (λ). Further, the SLA controller includes one or more processor configured to execute the executable instructions to cause the SLA controller to receive an input query from an external device. Further, the SLA controller is configured to determine, based on the input query and the target accuracy value (τ), a model selection preference for selecting one Machine Learning (ML) model from a plurality of ML models. The SLA controller is configured to update the scalar dual variable (λ) based on a realized accuracy associated with one or more routed input queries relative to the target accuracy value (τ). Further, the SLA controller is configured to update the model-selection preference based on the scalar dual variable (λ). The SLA controller is configured to apply the updated scalar dual variable (λ) to an accuracy-shortfall penalty associated with a difference between the realized accuracy and the target accuracy value (τ). Further, the SLA controller is configured to select, in a single-pass routing operation, the selected ML model based on the updated model-selection preference and a cost associated with the selected ML model.

In some embodiments, to update the scalar dual variable (λ), the SLA controller is configured to, one of increase the scalar dual variable (λ) when the realized accuracy is below the target accuracy value (τ) and decrease the scalar dual variable (λ) when the realized accuracy meets or exceeds the target accuracy value (τ). The realized accuracy is determined using at least one of a short-window average, a session average, and an exponentially weighted moving average.

In some embodiments, to update the model-selection preference, the SLA controller is configured to adjust an accuracy preference parameter using the scalar dual variable (λ). Further, the SLA controller is configured to represent the model-selection preference by a probability distribution. A mean of the probability distribution is shifted based on the scalar dual variable (λ) to bias selection toward a higher-accuracy ML model when the realized accuracy is below the target accuracy value (τ).

In some embodiments, the probability distribution is a beta distribution parameterized by a mean and a concentration, and the SLA controller is configured to constrain the mean and the concentration to reduce saturation of the model-selection preference at boundary values.

In some embodiments, the SLA controller is configured to determine a predicted performance and a cost for each of the plurality of ML models. Further, the SLA controller is configured to select the selected ML model based on the predicted performance and the cost.

In some embodiments, the SLA controller is configured to apply a bounded non-linear cost sensitivity parameter (Y) to the cost of at least one ML model to determine a cost penalty used in selecting the ML model.

In some embodiments, the SLA controller is configured to apply one or more stability guardrails including at least one of a warm-up period before updating the scalar dual variable (λ), a predefined step size for updating the scalar dual variable (λ), clipping of the scalar dual variable (λ), smoothing of realized accuracy using the short-window or the session-based average, and a regularization term to reduce oscillation of model-selection.

In another embodiment, a computer-implemented method for dual variable model routing control is disclosed. The method includes receiving an input query from an external device. Further, the method includes determining a model selection preference for selecting one Machine Learning (ML) model from a plurality of ML models based on the input query and the target accuracy value (τ). The method includes updating the scalar dual variable (λ) based on a realized accuracy associated with one or more routed input queries relative to the target accuracy value (τ). Further, the method includes updating the model-selection preference based on the scalar dual variable (λ). The method includes applying the updated scalar dual variable (λ) to an accuracy-shortfall penalty associated with a difference between the realized accuracy and the target accuracy value (τ). Further, the method includes selecting the ML model based on the updated model-selection preference and a cost associated with the selected ML model, in a single-pass routing operation.

In yet another embodiment, a non-transitory computer-readable storage medium having stored thereon computer executable instruction which when executed by one or more processors, cause the one or more processors to carry out a method for dual variable model routing control is disclosed. The method includes receiving an input query from an external device. Further, the method includes determining a model selection preference for selecting one Machine Learning (ML) model from a plurality of ML models based on the input query and the target accuracy value (τ). The method includes updating the scalar dual variable (λ) based on a realized accuracy associated with one or more routed input queries relative to the target accuracy value (τ). Further, the method includes updating the model-selection preference based on the scalar dual variable (λ). The method includes applying the updated scalar dual variable (λ) to an accuracy-shortfall penalty associated with a difference between the realized accuracy and the target accuracy value (τ). Further, the method includes selecting the ML model based on the updated model-selection preference and a cost associated with the selected ML model, in a single-pass routing operation.

### BRIEF DESCRIPTION OF DRAWINGS

Various embodiments disclosed herein will become better understood from the following detailed description when read with the accompanying drawings. The accompanying drawings constitute a part of the present disclosure and illustrate certain non-limiting embodiments of inventive concepts disclosed herein. Further, components and elements shown in the drawings are not necessarily to scale, emphasis instead being placed upon clearly illustrating the principles of the present disclosure. For the purpose of consistency and ease of understanding, similar components and elements are annotated by reference numerals in the exemplary drawings.

FIG. 1 illustrates a block diagram of an environment of a system for dual variable model routing control, in accordance with an example embodiment.

FIG. 2 illustrates a block diagram of a system architecture for dual variable model routing control, in accordance with an example embodiment.

FIG. 3 illustrates a flow diagram of a method for dual variable model routing control, in accordance with an example embodiment.

FIG. 4 illustrates an exemplary feedback-loop diagram for closed-loop dual variable model routing control, in accordance with an example embodiment.

FIG. 5 illustrates a block diagram of an exemplary computer system for implementing embodiments consistent with the present disclosure.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION OF THE INVENTION

Inventive concepts of the present disclosure will now be described more fully hereinafter with reference to the accompanying drawings, in which examples of one or more embodiments of inventive concepts are shown. Inventive concepts may, however, be embodied in different forms and should not be construed as limited to the embodiments set forth herein. Further, the one or more embodiments disclosed herein are provided to describe the inventive concept thoroughly and completely, and to fully convey the scope of each of the present inventive concepts to those skilled in the art. Furthermore, it should be noted that the embodiments disclosed herein are not mutually exclusive concepts. Accordingly, one or more components from one embodiment may be tacitly assumed to be present or used in any other embodiment.

The following description presents various embodiments of the present disclosure. The embodiments disclosed herein are presented as teaching examples and are not to be construed as limiting the scope of the present disclosure. The present disclosure should in no way be limited to the illustrative implementations, drawings, and techniques illustrated below, including the exemplary design and implementation illustrated and described herein, but may be modified, omitted, or expanded upon without departing from the scope of the present disclosure.

The following description contains specific information pertaining to embodiments in the present disclosure. The detailed description uses the phrases “in some embodiments” which may each refer to one or more or all of the same or different embodiments. The term “some” as used herein is defined as “one, or more than one, or all.” Accordingly, the terms “one,” “more than one,” “more than one, but not all” or “all” would all fall under the definition of “some.” In view of the same, the terms, for example, “in an embodiment” refers to one embodiment and the term, for example, “in one or more embodiments” refers to “at least one embodiment, or more than one embodiment, or all embodiments.”

The term “comprising,” when utilized, means “including, but not necessarily limited to,” it specifically indicates open-ended inclusion in the so-described one or more listed features, elements in a combination, unless otherwise stated with limiting language. Furthermore, to the extent that the terms “includes,” “has,” “have,” “contains,” and other similar words are used in either the detailed description, such terms are intended to be inclusive in a manner similar to the term “comprising.”

In the following description, for the purposes of explanation, various specific details are set forth to provide a thorough understanding of embodiments of the present disclosure. It will be apparent, however, that embodiments of the present disclosure may be practiced without these specific details. Several features described hereafter can each be used independently of one another or with any combination of other features.

The description provided herein discloses exemplary embodiments only and is not intended to limit the scope, applicability, or configuration of the present disclosure. Rather, the foregoing description of the exemplary embodiments will provide those skilled in the art with an enabling description for implementing any of the exemplary embodiments. Specific details are given in the following description to provide a thorough understanding of the embodiments. However, it may be understood by one of the ordinary skilled in the art that the embodiments disclosed herein may be practiced without these specific details.

The terminology used herein is for the purpose of describing particular embodiments only and is not intended to be limiting of the disclosure. As used herein the description, the singular forms “a”, “an”, and “the” include forms unless the context of the invention indicates otherwise.

The terminology and structure employed herein are for describing, teaching, and illuminating some embodiments and their specific features and elements and do not limit, restrict, or reduce the scope of the present disclosure. Accordingly, unless otherwise defined, all terms, and especially any technical and/or scientific terms, used herein may be taken to have the same meaning as commonly understood by one having ordinary skill in the art.

Service-Level Agreement (SLA) generally refers to a defined operational target or performance commitment associated with a computing service. In data processing and machine learning-based systems, an SLA may specify a target level for one or more service metrics, such as accuracy, latency, throughput, reliability, availability, or cost. The SLA may be defined by a system operator, service provider, application requirement, or contractual obligation, and may be used as a benchmark for evaluating whether the system is operating within an expected performance range.

In systems that employ multiple processing resources or models, SLA compliance may depend on how incoming requests are distributed among the available resources. For example, a lower-cost processing option may be sufficient for certain requests, whereas other requests may require a higher-capability processing option to satisfy a target service level. Accordingly, routing or selection decisions may influence whether the system maintains or deviates from the SLA over time. Because runtime conditions may vary, SLA satisfaction is often not a fixed property of a system, but rather a condition that may fluctuate based on observed outcomes. For this reason, some systems monitor operational results over a set of requests, a time window, or a session, and compare observed behaviour with a target SLA metric. Such comparison may be used to determine whether current processing decisions are adequately meeting the desired service level, and whether adaptive adjustment of future decisions may be required.

In an embodiment, a target service level may be represented by a target accuracy value (τ), which denotes a desired level of realized accuracy to be maintained by the SLA controller over runtime operation. The SLA controller may maintain a controller state represented by a scalar dual variable (λ), where the scalar dual variable (λ) is updateable based on observed service-level deviation relative to the target accuracy value (τ). In some embodiments, the scalar dual variable (λ) may be used as a minimal-state control signal for adapting future model-routing decisions without retraining one or more predictors or changing routing topology.

In some embodiments, an input query may be transformed into a latent representation z, which may be used by the SLA controller to determine a routing preference and to estimate model-wise performance and model-wise cost for a plurality of machine learning models. Further, a model-selection preference may be represented by an accuracy-seeking preference variable μ, and a bounded non-linear cost-sensitivity parameter may be represented by γ. For each candidate machine learning model m, the SLA controller may determine a predicted performance term Pm or perf[m], a predicted cost term Cm or cost[m], and, in some embodiments, a normalized cost term Ĉm derived from the predicted cost term.

In some embodiments, a realized accuracy used for control of the scalar dual variable 2 may be represented by r̅t, batch_acc, avg_session_acc, or another aggregated accuracy term computed over a predefined runtime interval. Such realized accuracy may be determined using at least one of a batch-wise accuracy, a short-window average, a session average, and an exponentially weighted moving average. Further, a step size used for updating the scalar dual variable λ may be represented by η or λ_lr, and an upper clipping bound for the scalar dual variable λ may be represented by λmax or λ_clip.

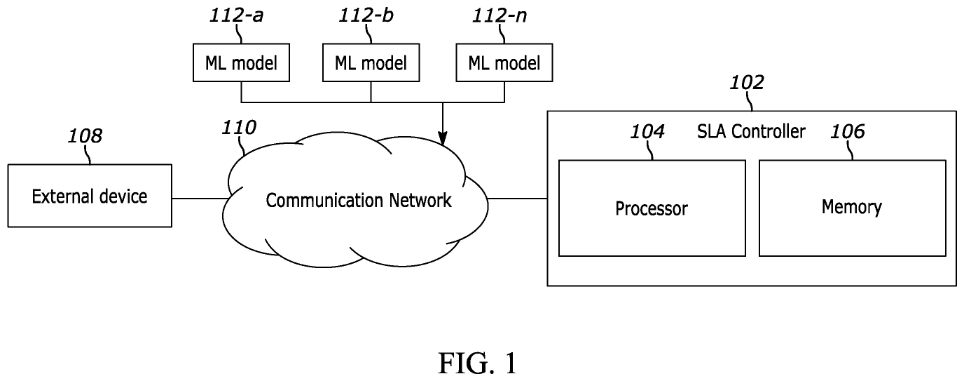

Embodiments of the present disclosure will be described below in detail with reference to the accompanying drawings. FIG. 1 through FIG. 4, discussed below, and the one or more embodiments used to describe the principles of the present disclosure are by way of illustration only and should not be construed in any way to limit the scope of the present disclosure. Those skilled in the art will understand that the principles of the present disclosure may be implemented in any suitably arranged system or device.

FIG. 1 illustrates a block diagram of an environment of a system 100 for dual variable model routing control, in accordance with an example embodiment. The system 100 includes a Service Level Agreement (SLA) controller 102, an external device 108, and a plurality of Machine Learning (ML) models 112a to 112n. The SLA controller 102 may be communicatively coupled with the external device 108 and the plurality of machine learning models 112a to 112n via a communication network 110. Examples of the SLA controller 102 may include, but are not limited to, a server, a computing device, a processing system, a controller, a cloud-based processing node, an edge processing node, or a combination thereof, or the like.

The communication network 110 may be wired, wireless, or any combination of wired and wireless communication networks, such as cellular, Wi-Fi, internet, local area networks, or the like. In one embodiment, the communication network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The SLA controller 102 may include a memory 106, and a processor 104. The term “memory” used herein may refer to any computer-readable storage medium, for example, volatile memory, random access memory (RAM), non-volatile memory, read only memory (ROM), or flash memory. The memory 106 may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 104 may retrieve computer program code instructions that may be stored in the memory 106 for execution of the computer program code instructions. The processor 104 may be embodied in a number of different ways. For example, the processor 104 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 104 may include one or more processing cores configured to perform independently. A multi-core processor may enable multiprocessing within a single physical package. Additionally, or alternatively, the processor 104 may include one or more processors configured in tandem via the bus to enable independent execution of instructions, pipelining, and/or multithreading.

Additionally, or alternatively, the processor 104 may include one or more processors capable of processing large volumes of workloads and operations to provide support for big data analysis. In an example embodiment, the processor 104 may be in communication with a memory 106 via a bus for passing information among components of the system 100.

The memory 106 may be non-transitory and may include, for example, one or more volatile and/or non-volatile memories. In other words, for example, the memory 106 may be an electronic storage device (for example, a computer readable storage medium) comprising gates configured to store data (for example, bits) that may be retrievable by a machine (for example, a computing device like the processor 104). The memory 106 may be configured to store information, data, contents, applications, instructions, or the like, for enabling the apparatus to carry out various functions in accordance with an example embodiment of the present disclosure. For example, the memory 106 may be configured to buffer input data for processing by the processor 104.

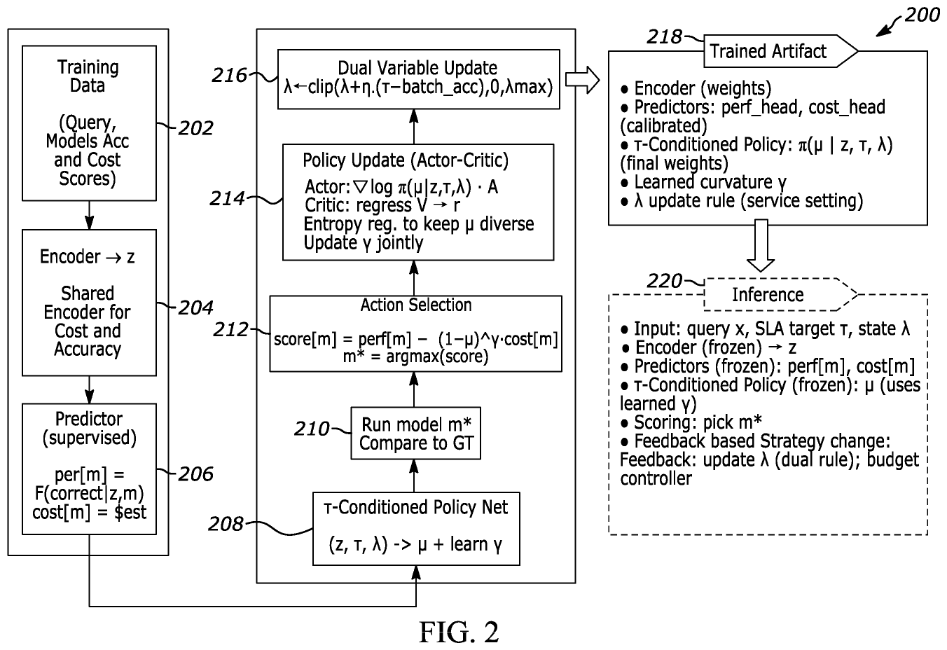

The SLA controller 102 may be capable of dual variable model routing control. The memory 106 may store instructions that, when executed by the processor 104, cause the SLA controller 102 to perform one or more operations of the present disclosure which will be described in greater detail in conjunction with FIG. 2. The SLA controller 102 is responsible for performing tasks such as receiving an input query from the external device 108, maintaining a target accuracy value and a controller state comprising a scalar dual variable, determining a model-selection preference for selecting one machine learning model 112 from a plurality of machine learning models 112 based on the input query and the target accuracy value, updating the scalar dual variable based on realized accuracy associated with one or more routed input queries relative to the target accuracy value, modifying the model-selection preference using the updated scalar dual variable, applying the updated scalar dual variable to an accuracy-shortfall penalty associated with a difference between the realized accuracy and the target accuracy value, determining a predicted performance and a cost for each of the plurality of machine learning models, and selecting, in a single-pass routing operation, a selected machine learning model based on the modified model-selection preference and the cost associated with the selected machine learning model. The plurality of machine learning models 112 may correspond to candidate ML models 112 having different accuracy, latency, and/or computational cost characteristics.

The external devices 108 may refers to various hardware and software tools that may be integrated with the system 100 to enhance its functionality. The complete process followed by the system 100 is explained in detail in conjunction with FIG. 2 to FIG. 4.

FIG. 2 illustrates a block diagram of a system architecture 200 for dual variable model routing control, in accordance with an example embodiment. The system architecture 200 may be implemented by the SLA controller 102 of the FIG. 1 for controlling selection of one ML model from a plurality of ML models while enforcing a target service level, such as a target accuracy. In an embodiment, the system architecture 200 includes a training data (Query, Models Acc and Cost Scores) block 202, an encoder (Shared Encoder for Cost and Accuracy) block 204, a predictor (supervised) block 206, a t-conditioned policy network block 208, a Run model block 210, an action selection block 212, a policy update (Actor-Critic) block 214, a dual variable update block 216, a trained artifact block 218, and an inference block 220.

In an embodiment, the training data (Query, Models Acc and Cost Scores) block 202 may include training samples associated with a plurality of input queries and corresponding supervision information. The supervision information may include, for example, model-wise correctness information, realized accuracy information, and model-wise cost information or cost scores. The training data (Query, Models Acc and Cost Scores) block 202 provides historical and/or labelled data used by the SLA controller 102 to learn how different candidate machine learning models perform for different types of input queries. In an aspect, the training data (Query, Models Acc and Cost Scores) block 202 provides a basis for jointly learning query representations, performance prediction, cost prediction, and routing behaviour under a target service level.

In an embodiment, the encoder (Shared Encoder for Cost and Accuracy) block 204 may receive the training data from the training data block 202 and may transform a given input query into a latent representation z. The encoder block 204 may be a shared encoder used for both cost-related and accuracy-related evaluation. More specifically, the encoder block 204 may generate a compact representation of the input query that is informative for predicting, for each candidate machine learning model, an expected performance measure and a corresponding cost measure. By using the same latent representation for both performance-related and cost-related estimation, the SLA controller 102 may generate a unified basis for subsequent routing decisions.

In an embodiment, the predictor (supervised) block 206 may receive the latent representation z from the encoder (Shared Encoder for Cost and Accuracy) block 204 and may generate model-wise estimates for the plurality of machine learning models. As shown in FIG. 2, the predictor (supervised) block 206 may estimate a performance value, such as a probability of correctness, for each candidate model, and may further estimate a corresponding cost value for each candidate model. For each model m, the predictor (supervised) block 206 may output a predicted performance term and a predicted cost term. The outputs may be used by the SLA controller 102 in determining which candidate machine learning model is better suited for handling a given input query while considering both expected quality and resource expenditure.

In some embodiments, the predictor (supervised) block 206 may generate, for each ML model m of the plurality of machine learning models, a predicted performance term Pm and a predicted cost term Cm based on the latent representation z generated by the encoder (Shared Encoder for Cost and Accuracy) block 204. The predicted performance term Pm may correspond to an estimated correctness probability, expected quality score, or another predicted suitability measure for the machine learning model with respect to the input query. The predicted cost term Cm may correspond to an estimated computational cost, monetary cost, latency burden, resource-consumption measure, or another cost-related quantity associated with using the machine learning model to process the input query.

In some embodiments, the predicted cost term Cm may be transformed into a normalized cost term Ĉm prior to model selection. For example, the SLA controller 102 may apply a scaler, normalization layer, pool-wise normalization process, running normalization process, or another cost-standardization mechanism to obtain the normalized cost term Ĉm. Such normalization may improve comparability of cost values across different machine learning models and may reduce instability arising from raw cost magnitudes that are not directly comparable.

In an embodiment, the τ-conditioned policy network block 208 may receive the latent representation z, a service-level target τ, and a controller state represented by a scalar dual variable λ. Based on the inputs, the τ-conditioned policy network block 208 may generate a model-selection preference as a policy parameter μ. In some embodiments, the policy parameter μ may correspond to an accuracy preference parameter used to influence the routing tendency of the SLA controller 102. The τ-conditioned policy network block 208 may adapt model-selection behaviour as a function of both query characteristics and service-level deviation information. In an aspect, the SLA controller 102 may determine routing preferences not merely from static query features, but also from the target service level and from the current control state associated with prior realized accuracy.

In some embodiments, the τ-conditioned policy network block 208 may receive the latent representation z, the target accuracy value τ, and the scalar dual variable λ, and may determine the model-selection preference based on these inputs. In an exemplary implementation, the τ-conditioned policy network block 208 may embed or otherwise encode the target accuracy value τ and the scalar dual variable λ, concatenate the encoded values with the latent representation z, and process the concatenated representation using one or more trainable layers to generate the model-selection preference.

In some embodiments, the model-selection preference may be represented by a Beta distribution over the accuracy-seeking preference variable μ. More particularly, the τ-conditioned policy network block 208 may generate a mean-related term m and a concentration-related term κ, where the mean-related term m may be determined according to:
m=σ(m_logits), where σ(⋅) denotes a sigmoid function, and the concentration-related term κ may be determined according to:
κ=softplus(k_logits)+κmin, where softplus(⋅) denotes a softplus function and κmin denotes a lower bound on concentration. The Beta distribution parameters may then be determined as:

$$α = m \cdot κ$$

$$β = ( 1 - m ) \cdot κ$$

such that the accuracy-seeking preference variable μ may be sampled from, or otherwise determined using, Beta(α, β).

In some embodiments, the scalar dual variable λ may be injected into the τ-conditioned policy network block 208 so as to shift the mean-related term m of the Beta distribution in a direction associated with increased preference for higher-accuracy models when the target accuracy value τ is under-satisfied. In an exemplary implementation, a λ-dependent effect term may be determined according to:
lambda_effect=tanh(a·λ), where a is a constant or learned coefficient, and the mean-related term m may be updated according to:
m←clamp(m+b·lambda_effect, mlow, mhigh), where b is a constant or learned coefficient, and mlow and mhigh define lower and upper bounds for the mean-related term m. In this manner, when the scalar dual variable λ increases, the resulting model-selection preference may be biased toward higher-accuracy machine learning models.

In some embodiments, the SLA controller 102 may further apply one or more anti-saturation constraints to the mean-related term m and/or the concentration-related term κ so as to reduce degeneration of the model-selection preference at boundary values. For example, the mean-related term m may be clamped to a predefined interval, such as an interval bounded away from 0 and 1, and the concentration-related term κ may be regularized around a target concentration value. Such constraints may preserve responsiveness of the model-selection preference while avoiding premature collapse of the routing policy.

In an embodiment, the action selection block 212 may receive the predicted performance terms and predicted cost terms from the predictor (supervised) block 206 and may further receive the model-selection preference generated by the τ-conditioned policy network block 208. The action selection block 212 may compute a score for each candidate model based on a combination of predicted performance and predicted cost. As shown in FIG. 2, the score may be formed by weighting a performance contribution and a cost contribution according to the model-selection preference. The SLA controller 102 may then determine a selected ML model based on the computed scores, for example by selecting the ML model associated with a highest score. Accordingly, the action selection block 212 enables the SLA controller 102 to select, in a single-pass routing operation, one ML model from the plurality of ML models for processing the input query.

In an embodiment, after the selected ML model has been determined, the Run model execution block 210 may cause the selected model to process the input query. The output of the selected model may then be evaluated relative to ground truth data, supervisory feedback, delayed labels, or other correctness criteria, so as to determine whether the selected model has satisfied the intended performance objective. The Run model execution block 210 provides realized outcome information that reflects actual quality achieved by the routing decision, realizing outcome information may subsequently be used by the SLA controller 102 in adjusting the controller state for future routing decisions.

In some embodiments, the action selection block 212 may determine, for each machine learning model m, a model-selection score based on the predicted performance term Pm or perf[m], the predicted cost term Cm or normalized cost term Ĉm, the model-selection preference u, and, in some embodiments, the bounded non-linear cost-sensitivity parameter γ. In an exemplary embodiment, the score for the machine learning model m may be determined according to:
score[m]=perf[m]−(1−μ)\hat{ }γ·cost[m] or, in another embodiment, according to:
score[m]=Pm−(1−μ)\hat{ }γ·Ĉm where γ is greater than zero and controls curvature of cost sensitivity. The selected machine learning model m* may then be determined according to:
m*=argmax (score[m]), across the plurality of machine learning models.

In some embodiments, the bounded non-linear cost-sensitivity parameter γ may be determined using a trainable scalar parameter and may be constrained to a bounded interval so as to preserve stable scoring behaviour. For example, the bounded non-linear cost-sensitivity parameter γ may be determined according to:
γ=clamp(cost_exponent, γlow, γhigh), where γlow and γhigh define lower and upper bounds on the bounded non-linear cost-sensitivity parameter γ. In some embodiments, the bounded non-linear cost-sensitivity parameter γ may be trained offline and retained during inference, while the scalar dual variable λ remains updateable online during runtime routing.

In some embodiments, the action selection block 212 may further apply a quality emphasis to one or more top-ranked machine learning models based on the model-selection preference u. For example, the SLA controller 102 may identify one or more machine learning models associated with comparatively high predicted performance and may apply a positive adjustment proportional to the model-selection preference u to reinforce selection of such machine learning models. Such quality emphasis may be used as an optional implementation detail and may remain consistent with single-pass routing of the input query.

In an embodiment, the policy update (Actor-Critic) block 214 may update one or more trainable parameters associated with the routing policy. The policy update (Actor-Critic) block 214 may be implemented using an actor-critic framework. For example, an actor component may learn or refine the routing policy, while a critic component may estimate a value function for policy optimization. The policy update (Actor-Critic) block 214 may further include entropy-based regularization so as to maintain policy diversity and reduce premature collapse to extreme routing preferences. In some embodiments, the policy update (Actor-Critic) block 214 may update the policy jointly with the dual variable update block 216. The policy update (Actor-Critic) block 214 may refine how the SLA controller 102 maps query representations, target service-level information, and controller state into routing preferences.

In some embodiments, the policy update (Actor-Critic) block 214 may train or refine the τ-conditioned policy network block 208 using an actor-critic framework. For example, an actor component may be trained using a gradient term based on ∇ log π(μ|z, τ, λ) and an advantage term, and a critical component may be trained to estimate a value function V associated with routing outcomes. Further, entropy regularization may be applied to maintain diversity in the model-selection preference μ, and the bounded non-linear cost-sensitivity parameter γ may be updated jointly during training.

In some embodiments, the policy update (Actor-Critic) block 214 may determine a base utility for a chosen machine learning model using a target-dependent weighting of quality and cost. By way of example, the SLA controller 102 may determine:

$$tau\_weight = norm ( τ )$$

$$accuracy\_weight = exp ( c 1 \cdot tau\_weight )$$

cost_weight_base=exp(c2·(1−tau_weight)), where norm(τ) denotes a normalized representation of the target accuracy value τ, and c1 and c2 are constants. A base reward or base utility may then be determined according to:

$$reward\_base = accuracy\_weight \cdot Pchosen \cdot k 1 - cos\_weight \_base \cdot \hat{C} chosen \cdot k 2$$

where Pchosen denotes the predicted performance of the selected machine learning model, Ĉchosen denotes the normalized cost of the selected machine learning model, and k1 and k2 are scaling constants.

In some embodiments, the policy update (Actor-Critic) block 214 may incorporate one or more constraint penalties associated with failure to satisfy the target accuracy value τ. For example, the SLA controller 102 may determine a batch-level accuracy shortfall according to:
acc_slack=ReLU(τ−batch_acc) and may determine an individual predicted shortfall according to:
individual_slack=ReLU(τ−Pchosen), where ReLU(·) denotes a rectified linear unit function. A reward term may then be determined according to:
reward=reward_base−λ·acc_slack·k3−accuracy_penalty·individual_slack, where k3 is a scaling constant and accuracy_penalty is a penalty coefficient. In this manner, the scalar dual variable λ may be injected into the objective path through a penalty associated with under-satisfaction of the target accuracy value τ.

In an embodiment, the dual variable update block 216 may update the scalar dual variable λ based on realized accuracy relative to the target service level t. As shown in FIG. 2, the dual variable update block 216 may implement an update rule in which the scalar dual variable λ is adjusted according to a difference between the target accuracy t and a realized accuracy measure, such as batch accuracy. For example, when the realized accuracy falls below the target accuracy, the scalar dual variable λ may be increased so as to bias future routing decisions toward higher-accuracy models. Conversely, when the realized accuracy meets or exceeds the target accuracy, the scalar dual variable λ may be reduced or relaxed. In an embodiment, the dual variable update block 216 may further clip the scalar dual variable within a predefined range to improve stability. The dual variable update block 216 provides a closed-loop control mechanism by which the SLA controller 102 uses observed service-level deviation to modify future routing behaviour.

In an embodiment, the scalar dual variable λ may be applied in at least two ways within the system architecture 200. First, the scalar dual variable λ may be provided as an input to the t-conditioned policy network block 208 so as to modify the model-selection preference generated for subsequent input queries. Second, the scalar dual variable λ may be used in connection with policy learning and/or reward evaluation so as to impose an accuracy-shortfall penalty associated with a difference between realized accuracy and target accuracy. By influencing both the routing preference generation path and the penalty path, the scalar dual variable λ enables coordinated enforcement of the target service level. In an aspect, the SLA controller 102 does not merely optimize for static cost-performance trade-offs, but rather performs dynamic, feedback-driven service-level enforcement.

In some embodiments, the dual variable update block 216 may update the scalar dual variable λ according to a dual-ascent style update rule based on realized accuracy relative to the target accuracy value τ. In an exemplary embodiment, the update rule may be expressed as:
Δt+1=clip(Δt+η(τ−r̅t), 0, λmax), where λt denotes a current scalar dual variable, η denotes an update step size, r̅t denotes a realized accuracy associated with a recent runtime interval, and λmax denotes an upper clipping bound. As a result, when the realized accuracy r̅t falls below the target accuracy value τ, the scalar dual variable λ may increase, and when the realized accuracy r̅t meets or exceeds the target accuracy value τ, the scalar dual variable λ may decrease or remain constrained.

In some embodiments, the realized accuracy r̅t used for updating the scalar dual variable λ may be determined from a short-window average, a session average, a batch-wise accuracy, an exponentially weighted moving average, or any combination thereof. The SLA controller 102 may maintain a history of recent routing outcomes and may compute an average session accuracy avg_session_acc from such history. The use of a short-window or session-based realized accuracy may enable the SLA controller 102 to detect runtime drift in query mix, model behaviour, or cost-performance characteristics and to respond using a lightweight controller state.

In some embodiments, the scalar dual variable λ may be injected into the system architecture 200 through at least two coordinated paths. First, the scalar dual variable λ may be supplied to the τ-conditioned policy network block 208 so as to bias the model-selection preference μ toward higher-accuracy machine learning models when the target accuracy value τ is under-satisfied. Second, the scalar dual variable λ may be supplied to the reward or penalty computation so as to increase a cost of under-performance when realized accuracy falls below the target accuracy value τ. Such coordinated use of the scalar dual variable λ in both the policy path and the objective path may provide closed-loop enforcement of the target service level.

In an embodiment, the outputs of training may be consolidated into the trained artifact block 218. As shown in FIG. 2, the trained artifact block 218 may include learned encoder weights, one or more predictors, a τ-conditioned policy, a learned curvature parameter such as γ, and an update rule associated with the scalar dual variable λ. The learned curvature parameter γ may define a bounded non-linear cost sensitivity used during model scoring, enabling the SLA controller 102 to capture non-linear cost behaviour rather than relying solely on linear cost treatment. Further, the trained artifact block 218 may store the policy and prediction components for use during runtime inference. In an embodiment, one or more elements of the trained artifact block 218 may be frozen for inference, while the scalar dual variable λ remains updateable online as part of runtime control.

In some embodiments, the trained artifact block 218 may store one or more trained and/or configured elements used by the SLA controller 102 during inference. The configured elements may include encoder weights, predictor weights, one or more calibrated performance heads, one or more calibrated cost heads, parameters of the τ-conditioned policy network block 208, parameters associated with the bounded non-linear cost-sensitivity parameter γ, normalization parameters used to obtain the normalized cost term Ĉm, and one or more parameters associated with the update rule of the scalar dual variable λ. In some embodiments, calibration parameters for predicted performance may include Platt-scaling parameters, temperature-scaling parameters, or other calibration parameters.

In an embodiment, the inference block 220 may implement deployment-time operation of the SLA controller 102. During inference, an input query, the target service level τ, and the current controller state λ may be provided to the inference block 220. The inference block 220 may then use a trained or frozen encoder to obtain the latent representation z, use trained or frozen predictors to obtain model-wise predicted performance and cost, and use the trained or frozen τ-conditioned policy to obtain a routing preference, such as μ, using the current scalar dual variable λ. The SLA controller 102 may compute scores for the candidate machine learning models, select the selected model, and route the input query to the selected model in a one-shot manner.

In an embodiment, the inference block 220 may also support feedback-based strategy change. For example, realized performance information obtained after deployment may be used to update the scalar dual variable λ using the update rule learned or defined during training. In an aspect, although the encoder, predictors, and routing policy may remain fixed or frozen during inference, the SLA controller 102 may continue to adapt runtime routing behaviour by updating the scalar dual variable λ based on observed service-level compliance, providing selector-agnostic closed-loop enforcement, since the routing adaptation can be performed through the controller state without requiring retraining of the underlying predictors or reconfiguration of the model-routing topology.

In some embodiments, during inference, the inference block 220 may receive an input query x, the target accuracy value τ, and a current controller state represented by the scalar dual variable λ. The encoder (Shared Encoder for Cost and Accuracy) block 204 may generate the latent representation z from the input query x, the predictor block 206 may generate the predicted performance term Pm and predicted cost term Cm for each machine learning model m, the τ-conditioned policy network block 208 may determine the model-selection preference μ, and the action selection block 212 may determine the selected machine learning model m* using the scoring rule described above. The selected machine learning model m* may then be executed in a one-shot manner without retry routing or cascade routing.

In some embodiments, the inference block 220 may preserve selector-agnostic closed-loop enforcement by keeping the encoder (Shared Encoder for Cost and Accuracy) block 204, the predictor (supervised) block 206, and the τ-conditioned policy network block 208 fixed or frozen during runtime operation while continuing to update the scalar dual variable λ based on realized accuracy. As a result, adaptation of runtime routing behaviour may be achieved by updating the scalar dual variable λ without retraining the predictors, without modifying the routing topology, and without introducing retry-based latency.

In an embodiment, the system architecture 200 may further support one or more stability guardrails for improving robustness of closed-loop routing control. The one or more stability guardrails may include clipping of the scalar dual variable λ, use of predefined update step sizes, smoothing of realized accuracy over a short window, a session, or an exponentially weighted moving average, application of warm-up periods before updating the scalar dual variable λ, and use of regularization terms that discourage collapse of the routing preference toward boundary values. The one or more stability guardrails may reduce oscillation, thrashing, or instability in routing behaviour in the presence of noisy labels, delayed feedback, or non-stationary query traffic.

In some embodiments, the system architecture 200 may further include one or more stability guardrails for improving robustness of closed-loop model routing control. The one or more stability guardrails may include a warm-up period before updating the scalar dual variable λ, a predefined update step size n, clipping of the scalar dual variable λ to a predefined interval, smoothing of realized accuracy using a short-window average, a session average, or an exponentially weighted moving average, entropy regularization, entropy decay, and one or more regularization terms associated with the Beta distribution parameterization.

In some embodiments, the one or more regularization terms associated with the Beta distribution parameterization may include an edge penalty configured to discourage degeneration of the mean-related term m toward boundary values. By way of example, the SLA controller 102 may determine an edge penalty according to:
−log(m(1−m)) and may further apply a concentration regularizer that encourages the concentration-related term κ to remain within a desired range. Such measures may reduce oscillation, thrashing, premature saturation of the model-selection preference, and instability in the presence of noisy labels, delayed feedback, or non-stationary traffic conditions.

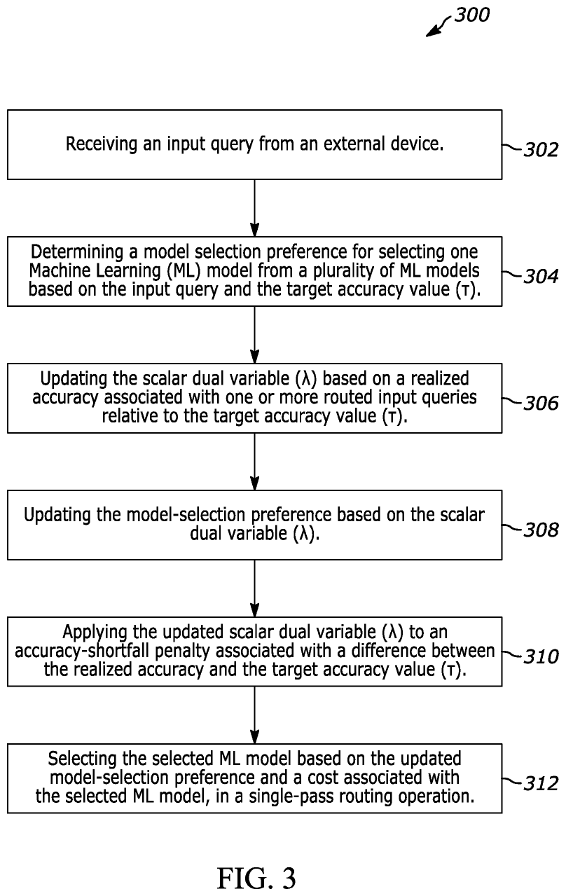

FIG. 3 illustrates a flow diagram of a method 300 for dual variable model routing control, in accordance with an example embodiment. The method 300 may be performed by the SLA controller 102 of FIG. 1. In an embodiment, the method 300 enables the SLA controller 102 to select one ML model from a plurality of ML models while maintaining a target service level, such as a target accuracy value τ, under changing runtime conditions.

At step 302, an input query is received from an external device. The input query may correspond to a text prompt, a classification request, a ranking request, a prediction request, or any other input to be processed by one of a plurality of available machine learning models. Upon receipt of the input query, the SLA controller 102 may initiate evaluation of candidate machine learning models suitable for processing the input query.

At step 304, a model selection preference for selecting one Machine Learning (ML) model from a plurality of ML models is determined based on the input query and the target accuracy value (τ). In an exemplary embodiment, the SLA controller 102 may generate a latent representation of the input query using an encoder and may process the latent representation together with the target accuracy value (τ) to determine a model-selection preference. The model-selection preference may indicate a routing tendency of the SLA controller 102 toward lower-cost models, higher-accuracy models, or a balanced trade-off therebetween. In some embodiments, the model-selection preference may be represented by an accuracy preference parameter that is conditioned on both query-dependent features and service-level information.

In some embodiments, determining the model-selection preference includes generating, by the SLA controller 102, a latent representation z of the input query and processing the latent representation z together with the target accuracy value τ and the scalar dual variable λ using a τ-conditioned policy. In an exemplary embodiment, the τ-conditioned policy may determine a mean-related term m and a concentration-related term κ according to:

$$m = σ ( m\_logits )$$

κ=softplus(k_logits)+κmin, and may determine Beta-distribution parameters according to:

$$α = m \cdot κ$$

β=(1−m)·κ, such that the model-selection preference μ is sampled from, or otherwise determined from, Beta(α, β).

At step 306, the scalar dual variable (λ) is updated based on a realized accuracy associated with one or more routed input queries relative to the target accuracy value (τ). To update the scalar dual variable (λ), the scalar dual variable (λ) is increased when the realized accuracy is below the target accuracy value (τ) or decreased when the realized accuracy meets or exceeds the target accuracy value (τ). The realized accuracy is determined using at least one of a short-window average, a session average, and an exponentially weighted moving average. In an exemplary embodiment, the SLA controller 102 may monitor outcomes of previously routed input queries and may determine whether an observed or realized accuracy satisfies the target accuracy value (τ). The realized accuracy may be computed over a short-window average, a session average, an exponentially weighted moving average, or any suitable aggregated measure of recent system performance. When the realized accuracy falls below the target accuracy value (τ), the SLA controller 102 may increase the scalar dual variable (λ) so as to place greater emphasis on accuracy in future routing decisions. Conversely, when the realized accuracy meets or exceeds the target accuracy value (τ), the SLA controller 102 may decrease or relax the scalar dual variable (λ). The scalar dual variable (λ) acts as a runtime control state reflecting service-level deviation.

In some embodiments, updating the scalar dual variable λ at step 306 includes determining a realized accuracy term r̅t from a recent runtime interval and applying a clipped dual-ascent style update according to:
λt+1=clip(λt+η(τ−r̅t), 0, λmax), where n denotes an update step size and λmax denotes an upper clipping bound. In an exemplary embodiment, the realized accuracy term r̅t may correspond to a short-window average, a session average, a batch accuracy, or an exponentially weighted moving average of recent routing outcomes.

At step 308, the model-selection preference is updated based on the scalar dual variable (λ). To update the model-selection preference, an accuracy preference parameter is adjusted using the scalar dual variable (λ). Further, the model-selection preference is represented by a probability distribution. A mean of the probability distribution is shifted based on the scalar dual variable (λ) to bias selection toward a higher-accuracy ML model when the realized accuracy is below the target accuracy value (τ). The probability distribution is a beta distribution parameterized by a mean and a concentration. Further, the mean and the concentration is constrained to reduce saturation of the model-selection preference at boundary values. In an exemplary embodiment, the SLA controller 102 may adjust the accuracy preference parameter using the updated scalar dual variable (λ). More particularly, the model-selection preference may be represented by a probability distribution, and a mean of the probability distribution may be shifted in accordance with the scalar dual variable (λ). When the scalar dual variable (λ) increases due to an accuracy shortfall, the mean may be shifted so as to bias selection toward a higher-accuracy machine learning model. Further, the SLA controller 102 may constrain the mean and/or the concentration to reduce saturation of the model-selection preference at boundary values, preventing collapse of routing behaviour toward extreme model-selection states and preserving responsiveness of the routing controller.

In some embodiments, updating the model-selection preference at step 308 includes injecting the updated scalar dual variable λ into a mean-related term of the policy distribution so as to bias future selections toward higher-accuracy machine learning models when the realized accuracy is below the target accuracy value τ. By way of example, the SLA controller 102 may determine:
lambda_effect=tanh(a·λ) and may update the mean-related term according to:
m←clamp(m+b·lambda_effect, mlow, mhigh), where a and b are constants or learned coefficients and mlow and mhigh denote lower and upper bounds. In this manner, the updated scalar dual variable λ may influence the model-selection preference through the policy path.

At step 310, the updated scalar dual variable (λ) is applied to an accuracy-shortfall penalty associated with a difference between the realized accuracy and the target accuracy value (τ). In an exemplary embodiment, the SLA controller 102 may determine an extent to which the realized accuracy is below the target accuracy value (τ) and may use the scalar dual variable (λ) to weight or scale a corresponding penalty term. The penalty term may be incorporated into a reward function, optimization function, policy refinement process, or any other control computation associated with routing adaptation. In an aspect, the scalar dual variable (λ) influences not only the routing preference itself, but also the penalty associated with failure to meet the target accuracy value (τ). Such dual use of the scalar dual variable (λ) may improve closed-loop enforcement of the target service level.

In some embodiments, applying the updated scalar dual variable λ to the accuracy-shortfall penalty at step 310 includes determining a batch-level shortfall according to:
acc_slack=ReLU(τ−batch_acc) and, optionally, an individual predicted shortfall according to:
individual_slack=ReLU(τ−Pchosen) and using the scalar dual variable λ to determine a penalty term associated with under-satisfaction of the target accuracy value τ. In an exemplary embodiment, a reward term may be determined according to:
reward=reward_base−λ·acc_slack·k3−accuracy_penalty·individual_slack, where reward_base is a base utility term, k3 is a scaling constant, and accuracy_penalty is a penalty coefficient.

At step 312, the ML model is selected based on the updated model-selection preference and a cost associated with the selected ML model, in a single-pass routing operation. In an embodiment, a predicted performance and a cost is determined, for each of the plurality of ML models. The predicted performance may indicate, for example, an expected probability of correctness or expected suitability of the machine learning model for the input query. The cost may indicate, for example, computational expense, inference resource usage, monetary cost, or latency-related burden. Based on the updated model-selection preference and the cost associated with each machine learning model, the SLA controller 102 may compute model-wise scores and may select a machine learning model having a preferred score. In some embodiments, the selection may be completed in a one-shot or single-pass routing operation without retry routing or cascade routing.

In some embodiments, selecting the machine learning model at step 312 includes determining, for each machine learning model m, a predicted performance term Pm and a predicted cost term Cm or normalized cost term Ĉm, and determining a model-selection score according to:
score[m]=perf[m]−(1−μ)\hat{ }γ·cost[m] or, in another embodiment,
score[m]=Pm−(1−μ)\hat{ }γ·Ĉm where γ denotes a bounded non-linear cost-sensitivity parameter. The SLA controller 102 may then select the machine learning model according to:
m*=argmax(score[m]) in a single-pass routing operation.

In some embodiments, a bounded non-linear cost sensitivity parameter (γ) is applied to the cost of at least one ML model to determine a cost penalty used in selecting the ML model. In an exemplary embodiment, the SLA controller 102 may transform a raw cost value through a bounded non-linear function governed by the parameter Y, so that cost differences between candidate machine learning models are reflected in a controlled and non-linear manner, allowing the SLA controller 102 to model more realistic cost behaviour and to avoid excessive sensitivity or insufficient sensitivity to cost variation during model selection.

In some embodiments, the bounded non-linear cost-sensitivity parameter γ may be determined from a trainable scalar parameter and constrained to a bounded interval, such as an interval between a predefined lower bound and a predefined upper bound, so as to avoid excessive sensitivity to cost variation. In some embodiments, the bounded non-linear cost-sensitivity parameter γ may be trained offline using a policy-gradient or REINFORCE-based mechanism and may remain fixed during runtime inference while the scalar dual variable λ continues to be updated online.

In an aspect, one or more stability guardrails including at least one of a warm-up period before updating the scalar dual variable (λ), a predefined step size for updating the scalar dual variable (λ), clipping of the scalar dual variable (λ), smoothing of realized accuracy using the short-window or the session-based average, and a regularization term are realized to reduce oscillation of model-selection. In an exemplary embodiment, the SLA controller 102 may apply the warm-up period before updating the scalar dual variable (λ), so that the controller state is not changed prematurely before sufficient routing outcomes are observed. Such guardrails may reduce instability, oscillation, or thrashing in routing behaviour, particularly in environments having noisy labels, delayed correctness feedback, or non-stationary query distributions.

In some embodiments, reducing oscillation of model selection includes applying one or more additional guardrail mechanisms comprising entropy regularization, entropy decay, concentration regularization for the concentration-related term κ, and an edge penalty associated with the mean-related term m. By way of example, the edge penalty may be expressed as:
−log(m(1−m)) so as to discourage collapse of the model-selection preference toward boundary values while preserving responsiveness of the control loop.

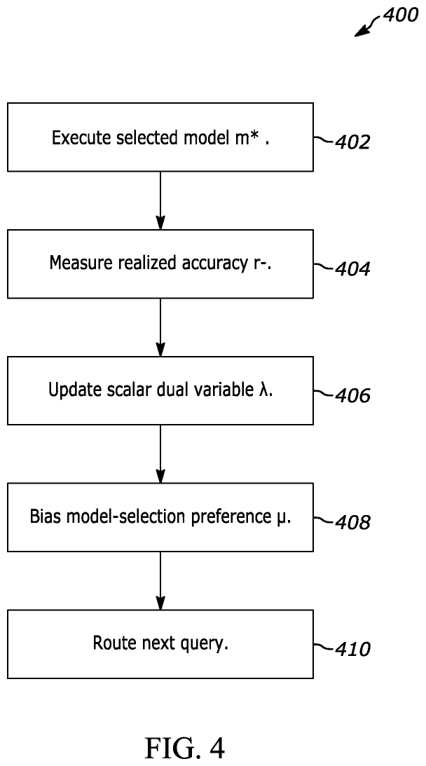

FIG. 4 illustrates an exemplary feedback-loop diagram for closed-loop dual variable model routing control, in accordance with an example embodiment. The feedback-loop diagram 400 is explained in conjunction with FIGS. 1-3. The feedback-loop diagram 400 depicts how the SLA controller 102 continuously adapts routing decisions over successive input queries based on realized runtime performance, while preserving a single-pass model selection framework for each individual query. In particular, the feedback-loop diagram 400 shows that, after a selected ML model 112 is used for processing the input query, performance information associated with that routing decision is fed back into the SLA controller 102 update procedure so that a subsequent routing decision may be adjusted in a controlled manner.

At step 402, a selected ML model m* is executed for a current input query. In an embodiment, the selected ML model m* corresponds to one ML model chosen from a plurality of ML models based on a model-selection preference determined by the SLA controller 102. Such preference may be based on the input query, predicted cost and accuracy information associated with candidate ML models, and a controller state represented by a scalar dual variable λ. The selected ML model m* may correspond to a lower-cost model, a higher-accuracy model, or an intermediate model depending on the prevailing control state.

At step 404, a realized accuracy r̅ associated with execution of the selected ML model m* is measured. In an embodiment, the realized accuracy r̅ may correspond to an observed or estimated quality metric for the routed query, a batch of routed queries, or a rolling window of queries. The realized accuracy r̅ indicates whether the current routing behaviour is underperforming, satisfying, or exceeding a target accuracy value τ.

At step 406, the scalar dual variable λ is updated based on the realized accuracy r̅. In an embodiment, the update is based on a difference between the realized accuracy r̅ and the target accuracy value τ. When the realized accuracy r̅ falls below the target accuracy value τ, the scalar dual variable λ may be increased to strengthen enforcement of the target accuracy value in subsequent routing decisions. When the realized accuracy r̅ meets or exceeds the target accuracy value τ, the scalar dual variable λ may be relaxed, maintained, or reduced.

At step 408, a model-selection preference μ is biased based on the updated scalar dual variable λ. Such biasing may shift routing toward ML models expected to provide higher accuracy when SLA compliance is at risk, and toward lower-cost ML models when sufficient accuracy margin exists. At step 410, the next query is routed using the biased model-selection preference μ.

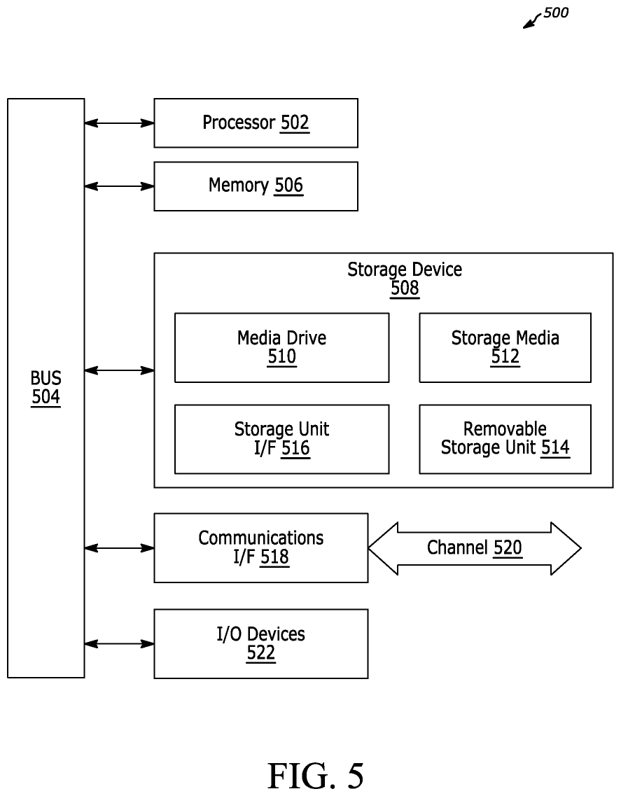

The disclosed methods and systems may be executed on a conventional or general-purpose computing system, such as a personal computer (PC) or server. Referring to FIG. 5, an exemplary computing system 500 is illustrated, which may implement processing functionality for various embodiments (e.g., as a SIMD device, client device, server device, or one or more processors). Those skilled in the art will recognize that other computing systems or architectures may also be used to implement the invention. The computing system 500 may represent a user device, such as a desktop, laptop, mobile phone, personal entertainment device, DVR, or any other special or general-purpose computing device appropriate for a given application or environment. The computing system 500 may include one or more processors, such as processor 502, implemented using a general-purpose or specialized processing engine, such as a microprocessor, microcontroller, or other control logic. In some embodiments, processor 502 may be an AI processor, implemented as a Tensor Processing Unit (TPU), graphical processing unit (GPU), or custom-programmable solution, such as a Field-Programmable Gate Array (FPGA).

The computing system 500 may further include memory 506 (e.g., Random Access Memory (RAM) or other dynamic memory) for storing instructions and information to be executed by processor 502. Memory 506 may also store temporary variables or intermediate information during execution. Additionally, the computing system 500 may include a read-only memory (ROM) or other static storage device connected to bus 504 for storing static information and instructions for processor 502.

Storage devices 508 may also be included in computing system 500, consisting of, for example, a media drive 510 and a removable storage interface. Media drive 510 may support fixed or removable storage media, such as hard disk drives, floppy drives, magnetic tape drives, SD card ports, USB ports, optical disk drives (e.g., CD or DVD drives), or other media. Storage media 512 may include hard disks, magnetic tapes, flash drives, or other media that can be read and written to by media drive 510. Storage media 512 may store computer-readable software or data.

Alternatively, storage devices 508 may include other means for loading computer programs or data into computing system 500, such as removable storage unit 514 and storage unit interface 516, program cartridges, removable memory (e.g., flash memory), memory slots, and similar storage units and interfaces.

Computing system 500 may also include a communications interface 518 to transfer software and data between external devices 108 and system 100. Examples include network interfaces (e.g., Ethernet), communication ports (e.g., USB, micro-USB), Near Field Communication (NFC), and other protocols. The signals transferred via communications interface 518 may include electronic, electromagnetic, optical, or other forms of transmission through channel 520, which may utilize wireless mediums, fibre optics, wires, or cables.

Computing system 500 may also include Input/Output (I/O) devices 522, such as a display, keypad, microphone, speakers, vibration motors, LED indicators, etc., allowing user interaction and feedback. The term “computer-readable medium” may refer to any storage medium used, such as memory 506, storage devices 508, removable storage unit 514, or signal(s) on channel 520. Such media may store sequences of instructions, or “computer program code,” which, when executed, enable computing system 500 to perform the methods and functions described in embodiments of the invention.

In embodiments where elements are implemented in software, the software may be stored on a computer-readable medium and loaded into computing system 500 via removable storage unit 514, media drive 510, or communications interface 518. When executed by processor 502, this control logic (e.g., software instructions or computer program code) causes processor 502 to perform the invention's functions as described.

As will be appreciated by those skilled in the art, the techniques described in the various embodiments discussed above are not routine, or conventional, or well understood in the art. The techniques discussed above provide for innovative solutions to address the challenges associated with maintaining target accuracy during dynamic query routing across multiple models under changing runtime conditions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present disclosure provides several technical advantages over conventional model routing and service-level management techniques. In particular, the disclosed system enables dynamic enforcement of a target service level, such as target accuracy, during runtime operation of a multi-model processing environment. Unlike static routing approaches that rely on fixed thresholds, offline-calibrated trade-off settings, or preconfigured model preferences, the present disclosure introduces a feedback-driven control mechanism that adapts routing behaviour based on observed performance outcomes. As a result, the disclosed system may more effectively maintain service-level compliance under changing query distributions, non-stationary traffic conditions, and varying model behaviour. The present disclosure may update a scalar dual control variable and apply to influence future routing decisions without requiring repeated retraining of the underlying predictors or restructuring of the routing framework, improving deployment flexibility and reduces computational overhead associated with conventional adaptation mechanisms. Another technical advantage is that the present disclosure jointly accounts for predicted performance and predicted cost when selecting a model, enabling improved resource utilization while preserving a desired level of output quality. The present disclosure also improves stability of runtime routing through guardrail mechanisms such as bounded updates, clipping, smoothing, and controlled policy adaptation, thereby reducing oscillation and thrashing in routing behaviour. Additionally, the present disclosure supports single-pass model selection, which reduces latency and avoids inefficiencies associated with retry-based or cascade-based routing. Consequently, the present disclosure provides a technically improved routing control framework that enhances service-level reliability, computational efficiency, adaptability, and operational robustness in machine learning inference systems.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A system for dual variable model routing control, the system comprising:
a Service Level Agreement (SLA) controller comprising:
a memory configured to store executable instructions, a target accuracy value (τ), and a controller state comprising a scalar dual variable (λ); and
one or more processors configured to execute the executable instructions to cause the SLA controller to:
receive an input query from an external device;
determine, based on the input query and the target accuracy value (τ), a model selection preference for selecting one Machine Learning (ML) model from a plurality of ML models;
update the scalar dual variable (λ) based on a realized accuracy associated with one or more routed input queries relative to the target accuracy value (τ);
update the model-selection preference based on the scalar dual variable (λ);
apply the updated scalar dual variable (λ) to an accuracy-shortfall penalty associated with a difference between the realized accuracy and the target accuracy value (τ); and
select, in a single-pass routing operation, one ML model from the plurality of ML model based on the updated model-selection preference and a cost associated with the selected ML model.

2. The system of claim 1, wherein to update the scalar dual variable (λ), the SLA controller is configured to, one of:
increase the scalar dual variable (λ) when the realized accuracy is below the target accuracy value (τ); and
decrease the scalar dual variable (λ) when the realized accuracy meets or exceeds the target accuracy value (τ),
wherein the realized accuracy is determined using at least one of a short-window average, a session average, and an exponentially weighted moving average.

3. The system of claim 1, wherein to update the model-selection preference, the SLA controller is configured to:
adjust an accuracy preference parameter using the scalar dual variable (λ); and
represent the model-selection preference by a probability distribution, wherein a mean of the probability distribution is shifted based on the scalar dual variable (λ) to bias selection toward a higher-accuracy ML model when the realized accuracy is below the target accuracy value (τ).

4. The system of claim 3, wherein the probability distribution is a beta distribution parameterized by a mean and a concentration, and wherein the SLA controller is configured to constrain the mean and the concentration to reduce saturation of the model-selection preference at boundary values.

5. The system of claim 1, wherein the SLA controller is configured to:
determine a predicted performance and a cost for each of the plurality of ML models; and
select one ML model from the plurality of ML model based on the predicted performance and the cost.

6. The system of claim 5, wherein the SLA controller is configured to apply a bounded non-linear cost sensitivity parameter (γ) to the cost of at least one ML model to determine a cost penalty used in selecting the ML model.

7. The system of claim 1, wherein the SLA controller is configured to apply one or more stability guardrails comprising at least one of a warm-up period before updating the scalar dual variable (λ), a predefined step size for updating the scalar dual variable (λ), clipping of the scalar dual variable (λ), smoothing of realized accuracy using the short-window or the session-based average, and a regularization term to reduce oscillation of model-selection.

8. The system of claim 1, wherein to update the scalar dual variable (λ) during runtime inference, the SLA controller is configured to maintain an encoder, one or more predictors, and a policy network in a fixed state to adapt routing behaviour without retraining the encoder, the one or more predictors, or the policy network.

9. The system of claim 1, wherein the scalar dual variable (λ) is applied through at least two coordinated paths, comprising:
modifying the model-selection preference by biasing an accuracy preference parameter of a policy network; and
weighting the accuracy-shortfall penalty in an objective function influenced by the scalar dual variable (λ).

10. A computer-implemented method for dual variable model routing control, the method comprising:
maintaining, by a Service Level Agreement (SLA) controller, a target accuracy value (τ) and a controller state comprising a scalar dual variable (λ);
receiving, by a SLA controller, an input query from an external device;
determining, by the SLA controller, a model selection preference for selecting one Machine Learning (ML) model from a plurality of ML models based on the input query and the target accuracy value (τ);
updating, by the SLA controller, the scalar dual variable (λ) based on a realized accuracy associated with one or more routed input queries relative to the target accuracy value (τ);
updating, by the SLA controller, the model-selection preference based on the scalar dual variable (λ);
applying, by the SLA controller, the updated scalar dual variable (λ) to an accuracy-shortfall penalty associated with a difference between the realized accuracy and the target accuracy value (τ); and
selecting, by the SLA controller, the ML model based on the updated model-selection preference and a cost associated with the selected ML model, in a single-pass routing operation.

11. The computer-implemented method of claim 10, updating the scalar dual variable (λ) comprises one of:
increasing the scalar dual variable (λ) when the realized accuracy is below the target accuracy value (τ); and
decreasing the scalar dual variable (λ) when the realized accuracy at meets or exceeds the target accuracy value (τ),
wherein the realized accuracy is determined using at least one of a short-window average, a session average, and an exponentially weighted moving average.

12. The computer-implemented method of claim 10, wherein updating the model-selection preference, further comprising:
adjusting an accuracy preference parameter using the scalar dual variable (λ); and
representing the model-selection preference by a probability distribution, wherein a mean of the probability distribution is shifted based on the scalar dual variable (λ) to bias selection toward a higher-accuracy ML model when the realized accuracy is below the target accuracy value (τ).

13. The computer-implemented method of claim 12, wherein the probability distribution is a beta distribution parameterized by a mean and a concentration.

14. The computer-implemented method of claim 12, further comprising:
constraining the mean and the concentration to reduce saturation of the model-selection preference at boundary values.

15. The computer-implemented method of claim 10, further comprising:
determining a predicted performance and a cost, for each of the plurality of ML models; and
selecting one ML model from the plurality of ML model based on the predicted performance and the cost.

16. The computer-implemented method of claim 15, further comprising:
applying a bounded non-linear cost sensitivity parameter (γ) to the cost of at least one ML model to determine a cost penalty used in selecting the ML model.

17. The computer-implemented method of claim 10, further comprising:
applying one or more stability guardrails comprising at least one of a warm-up period before updating the scalar dual variable (λ), a predefined step size for updating the scalar dual variable (λ), clipping of the scalar dual variable (λ), smoothing of realized accuracy using the short-window or the session-based average, and a regularization term to reduce oscillation of model-selection.

18. The computer-implemented method of claim 10, updating the scalar dual variable (λ), further comprising:
maintaining an encoder, one or more predictors, and a policy network in a fixed state to adapt routing behaviour without retraining the encoder, the one or more predictors, or the policy network.

19. The computer-implemented method of claim 10, wherein the scalar dual variable (λ) is applied through at least two coordinated paths, comprising:
modifying the model-selection preference by biasing an accuracy preference parameter of a policy network; and
weighting the accuracy-shortfall penalty in an objective function influenced by the scalar dual variable (λ).

20. A non-transitory computer-readable storage medium having stored thereon computer executable instruction which when executed by one or more processors, cause the one or more processors to carry out a method for dual variable model routing control, the method comprising:
maintaining, by a Service Level Agreement (SLA) controller, a target accuracy value (τ) and a controller state comprising a scalar dual variable (λ);
receiving, by a Service Level Agreement (SLA) controller, an input query from an external device;
determining, by the SLA controller, a model selection preference for selecting one Machine Learning (ML) model from a plurality of ML models based on the input query and the target accuracy value (τ);
updating, by the SLA controller, the scalar dual variable (λ) based on a realized accuracy associated with one or more routed input queries relative to the target accuracy value (τ);
updating, by the SLA controller, the model-selection preference based on the scalar dual variable (λ);
applying, by the SLA controller, the updated scalar dual variable (λ) to an accuracy-shortfall penalty associated with a difference between the realized accuracy and the target accuracy value (τ); and
selecting, by the SLA controller, one ML model from the plurality of ML model based on the updated model-selection preference and a cost associated with the selected ML model, in a single-pass routing operation.
